(19) United States
(12) Patent Application Publication
(10) Pub. No.: US 2012/0085477 A1
(43) Pub. Date: Apr. 12, 2012

(54) PNEUMATIC TIRE WITH A WOVEN OR KNITTED REINFORCEMENT

(76) Inventors: Yves Donckels, Natoye (BE); Jesse Scott Roeck, Copley, OH (US); Serge Julien Auguste Imhoff, Grand Duchy (LU); Raphael Beck, Reichlange (LU)

(21) Appl. No.: 12/899,749

(22) Filed: Oct. 7, 2010

(51) Int. Cl. B60C 9/11; B60C 9/02

(52) U.S. Cl. 152/556; 152/563; 152/557

(57) ABSTRACT

A pneumatic tire has an axis of rotation. The pneumatic tire includes a reinforced ply placed in a predetermined location on a toroidal surface, a tread disposed radially outward of the reinforced ply, and a belt structure disposed radially between the reinforced ply and the tread. The reinforced ply includes at least one layer of an open construction woven or knitted fabric having warp yarns extending in a circumferential direction and weft yarns extending in a radial direction.

### FIELD OF THE INVENTION

The present invention relates to a pneumatic tire, and more particularly, to a less costly and more quickly manufactured pneumatic tire.

### BACKGROUND OF THE INVENTION

Historically, the pneumatic tire has been fabricated as a laminate structure of generally toroidal shape having beads, a tread, belt reinforcement, and a carcass. The tire is made of rubber, fabric, and steel. The manufacturing technologies employed for the most part involved assembling the many tire components from flat strips or sheets of material. Each component is placed on a building drum and cut to length such that the ends of the component meet or overlap creating a splice.

In the first stage of assembly, the prior art carcass will normally include one or more plies, and a pair of sidewalls, a pair of apexes, an innerliner (for a tubeless tire), a pair of chafers and perhaps a pair of gum shoulder strips. Annular bead cores can be added during this first stage of tire building and the plies can be turned around the bead cores to form the ply turnups. Additional components may be used or even replace some of those mentioned above.

This intermediate article of manufacture would be cylindrically formed at this point in the first stage of assembly. The cylindrical carcass is then expanded into a toroidal shape after completion of the first stage of tire building. Reinforcing belts beneath the tread are added to this intermediate article during a second stage of tire manufacture, which can occur using the same building drum or work station. This form of manufacturing a tire from flat components that are then toroidally formed limits the ability of the tire to be produced in an optimally uniform fashion.

Conventionally, it has been proposed to lay carcass plies in hoops or arcs having the ends of the carcass plies extending in a circumferential direction. A tire made this way may be dispensed of any circular bead core in the beads and the carcass would not have any lateral parts turned up radially with edges delimited by cut cables. While initially this process was not commercially viable, further developments have occurred constructing a ply using hoops of circular arcs so that the individual ply cords are laid across a convex toroidal cross section in an early stage of manufacture, converse to being made in the flat construction. The cords may thus extend in linear paths across the carcass. Early versions have included wrapping the ply cords around bead cores to effect a change in cord direction. These ply cords have been placed in tension around a circular arcuate shape in the course of manufacture. Later versions have included turning these linearly extending cords in opposite directions and sandwiching them between radially extending bead layers.

A similar conventional process simultaneously produces multiple arches using multiple cords in the process of manufacturing the carcass ply in an effort to speed the rate of manufacture. This process provides each of the circumferential portions being made from a single fine cord and the distance between cords, or the pitch, being very narrow. Thus, an array of cords has increased the pitch between cords as the array is applied.

In these conventional methods of manufacturing ply cords on a toroidal surface, it has been determined that a tension in the cords is optimal and that the cords should be laid in a straight line on a convex surface from turnaround to turnaround. In other words, a cord angle may be arranged other than 90° . However, 90° is a preferred orientation for the cord path because 90° mitigates likelihood of slippage off angle because 90° is the shortest ply path. Conventionally, these angles could not be adjusted in any fashion other than to provide a linear path because the tension placed on the cord during manufacture is required as the cord is being applied on the round or convex surface. In each conventional step, a carcass ply uses a technique called “winding” wherein the turnarounds apply tension across the entire cord path. Such a tire winding step for applying ply cords can only work on a convex surface and does not allow “placement” on a concave toroidal shape, as occurs in the sidewall regions, near the beads of the tire.

Another conventional method manufactures ply cords that allow placement on concave and convex surfaces, similar to the shape of a finished tire. This method does not require tension from turnaround to turnaround as the cord path is being established, thereby permitting nonlinear cord paths. Further, the cord loop endings, or turnarounds, may occur at different diameters and placement of the ply cords may be such that toroidially shaped ply cords may include forming turnups and allowing anchoring the ply using the bead cores. Additionally, the pitch between the cords may uniformly increase as the diameter increases along the cord path. The cord pitch increases uniformly as the diameter increases along the ply path due to a coordinated differential motion between the application of the cord and the movement of the toroidal surface.

The structure of a conventional pneumatic tire typically includes a pair of axially separated inextensible beads. A circumferentially disposed bead filler apex extends radially outward from each respective bead. At least one carcass ply extends between the two beads. The carcass ply has axially opposite end portions, each of which is turned up around a respective bead and secured thereto. Tread rubber and sidewall rubber is located axially and radially outward, respectively, of the carcass ply.

The bead area is one part of the tire that contributes a substantial amount to the rolling resistance of the tire, due to cyclical flexure which also leads to heat buildup. Under conditions of severe operation, as with runflat and high performance tires, the flexure and heating in the bead region can be especially problematic, leading to separation of mutually adjacent components that have disparate properties, such as the respective moduli of elasticity. In particular, the ply turnup ends may be prone to separation from adjacent structural elements of the tire.

A conventional ply may be reinforced with materials such as nylon, polyester, rayon, and/or metal, which have much greater stiffness (i.e., modulus of elasticity) than the adjacent rubber compounds of which the bulk of the tire is made. The difference in elastic modulus of mutually adjacent tire elements may lead to separation when the tire is stressed and deformed during use.

A variety of conventional design approaches have been used to control separation of tire elements in the bead regions of a tire. For example, one method has been to provide a “flipper” surrounding the bead and the bead filler. The flipper works as a spacer that keeps the ply from making direct contact with the inextensible beads, allowing some degree of relative motion between the ply, where it turns upward under the bead, and the respective beads. In this role as a spacer, a flipper may reduce disparities of strain on the ply and on the adjacent rubber components of the tire (e.g., the filler apex, the sidewall rubber, in the bead region, and the elastomeric portions of the ply itself).

The flipper may be made of a square woven cloth that is a textile in which each fiber, thread, or cord has a generally round cross-section. When a flipper is cured with a tire, the stiffness of the fibers/cords becomes essentially the same in any direction within the plane of the textile flipper.

In addition to the use of flippers as a means by which to reduce the tendency of a ply to separate, or as an alternative, another method that has been used involves the placement of “chippers.” A chipper is a circumferentially deployed metal or fabric layer that is disposed within the bead region in the portion of the tire where the bead fits onto the wheel rim. More specifically, the chipper lies inward of the wheel rim (i.e., toward the bead) and outward (i.e., radially outward, relative to the bead viewed in cross section) of the portion of the ply that turns upward around the bead. Chippers serve to stiffen, and increase the resistance to flexure of, the adjacent rubber material, which itself is typically adjacent to the turnup ply endings.

### SUMMARY OF THE INVENTION

In accordance with the present invention, a pneumatic tire has an axis of rotation. The pneumatic tire includes a reinforced ply placed in a predetermined location on a toroidal surface, a tread disposed radially outward of the reinforced ply, and a belt structure disposed radially between the reinforced ply and the tread. The reinforced ply includes at least one layer of an open construction woven or knitted fabric having warp yarns extending in a circumferential direction and weft yarns extending in a radial direction.

In one aspect of the present invention, the woven fabric has a 5 EPI to 18 EPI warp pair construction and a 5 EPI to 35 EPI weft construction.

In another aspect of the present invention, the warp yarns are 1220/1 Dtex rayon and the weft yarns are 1840/2 Dtex rayon or 2200/2 Dtex polyester. Other examples of weft constructions may be: 1100/2, 1440/2, 1670/2, 2200/2 polyester or 1220/2, 1840/2, 1840/3, 2440/2 Dtex rayon.

In still another aspect of the present invention, the warp yarns have a density of 18 EPI and the weft yarns have a density of 12 EPI.

In still another aspect of the present invention, the fabric has a LENO 2T or knitted configuration with a 5 EPI to 18 EPI warp pair construction and a 5 EPI to 35 EPI weft construction.

In yet another aspect of the present invention, the warp yarns have a density of 14 EPI and the weft yarns have a density of 26 EPI.

In still another aspect of the present invention, the pneumatic tire is a high performance tire.

In yet another aspect of the present invention, the woven fabric further comprises an adhesion promoter disposed thereon.

In still another aspect of the present invention, the reinforcing structure of the carcass has one or more layers of woven fabric.

In yet another aspect of the present invention, the warp yarns comprise at least two fibers of different fiber materials.

In still another aspect of the present invention, the woven or knitted fabric of the reinforced ply is constructed by placing a series of strips adjacent to each other.

### DEFINITIONS

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa@0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Knitted” means intertwining threads in a series of connected loops. For example, knitted may define a method by which thread or yarn is turned into a fabric of consecutive loops, called stitches. As each row of stitches progresses, a new loop may be pulled through an existing loop.

“LASE” is load at specified elongation.

“Lateral” means an axial direction.

“Lay length” means the distance at which a twisted filament or strand travels to make a 360 degree rotation about another filament or strand.

“Mega Tensile Steel (MT)” means a carbon steel with a tensile strength of at least 4500 MPa@0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa@0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Super Tensile Steel (ST)” means a carbon steel with a tensile strength of at least 3650 MPa@0.20 mm filament diameter.

“Tenacity” is stress expressed as force per unit linear density of the unstrained specimen (gmAex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa@0.20 mm filament diameter.

“Woven” means interlacing lengthwise yarns (warp) with filling yarns (weft). The interlaced yarns may be two or more sets of yarns at right angles to each other.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### BRIEF DESCRIPTION OF THE DRAWINGS

The structure, operation, and advantages of the present invention will become more apparent upon contemplation of the following description as viewed in conjunction with the accompanying drawings, wherein:

FIG. 1 shows a perspective view of the apparatus for use with the present invention;

FIGS. 2 and 3 illustrate cross-sectional views of a toroidal mandrel of the apparatus of FIG. 1;

FIGS. 4 through 9 show schematic views of a single cord being placed in a predetermined cord path in a flat view;

FIGS. 10 through 15 show a schematic view of the cords being applied on the toroidal mandrel;

FIG. 16 shows a schematic view of dispensing a plurality of cords simultaneously;

FIG. 17 shows a partial side view of an exemplary cord path;

FIG. 18 is a partial flat view of the exemplary cord path of FIG. 14 showing both sides of the ply path;

FIGS. 19 through 25 show a variety of exemplary ply path designs;

FIG. 26 illustrates cross-sectional views of the toroidal mandrel of the present invention having alternative cord path placement thereon;

FIG. 27 represents a schematic cross-sectional view of an example tire for use with the present invention;

FIG. 28 represents a schematic detail view of the bead region of the example tire shown in FIG. 27;

FIG. 29 represents a schematic detail of an example fabric structure in accordance with the present invention; and

FIG. 30 represents a schematic detail of another example fabric structure in accordance with the present invention.

### DETAILED DESCRIPTION OF THE ILLUSTRATIVE EMBODIMENTS

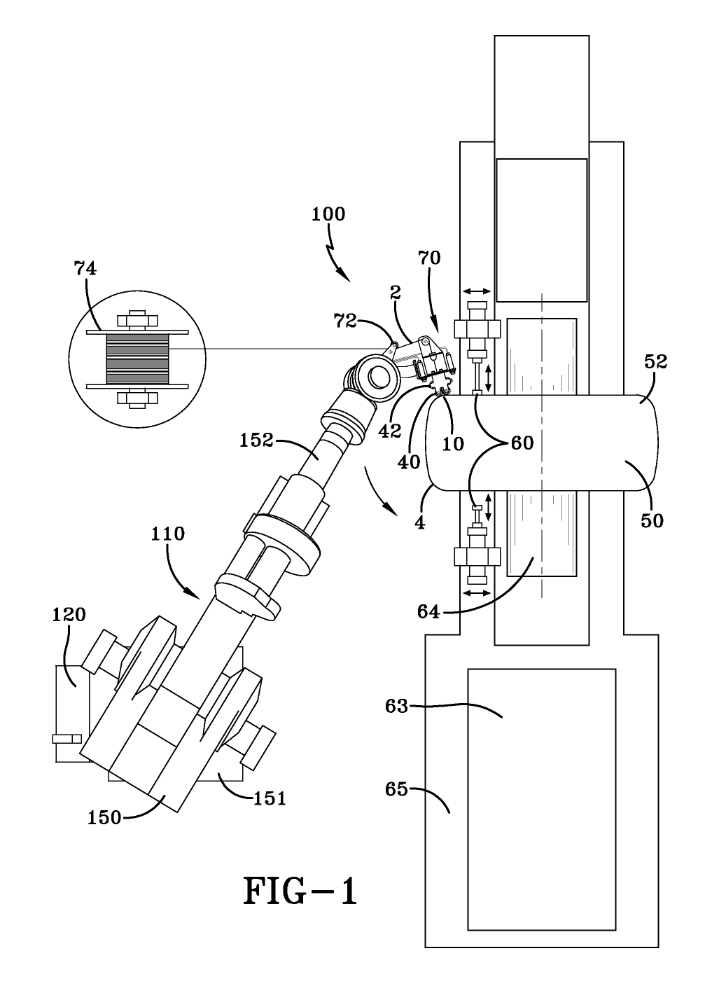

With reference to FIG. 1, a perspective view of an apparatus 100 for use with the present invention is illustrated. The apparatus 100 has a guide means which has, in addition to a ply mechanism 70, a robotic computer controlled system 110 for placing a ply cord 2 onto a toroidal surface 50. A means for applying an elastomeric layer 4 onto a mandrel 52 is provided which may include a server mechanism (not shown) to feed strips of the elastomeric layer 4 to the mandrel 52.

The robotic computer controlled system 110 has a computer 120 and preprogrammed software which dictates a ply path 10 to be used for a particular tire size. Each movement of the system 110 can be precisely articulated. The robot 150, which is mounted on a pedestal 151, has a robotic arm 152 which can be moved in six axes. The manipulated robotic arm 152 is attached to the ply mechanism 70 as shown.

Loop end forming mechanisms 60 are positioned on each side 56 of the toroidal mandrel 52. The robotic arm 152 feeds the ply cord 2 in predetermined paths 10 and the loop end forming mechanism 60 holds the ply cord 2 in place as a looped end 12 is formed. Each time a looped end 12 is formed, the toroidal mandrel 52 is rotated to index to a next pitch P and an adjacent ply path 10 around the toroidal mandrel 52.

The movement of the ply mechanism 70 permits convex curvatures to be coupled to concave curvatures near the bead areas, thus mimicking the final, as molded, shape of the pneumatic tire. A means 63 for rotating the mandrel 52 about an axle 64 may be mounted to a rigid frame 65 as shown.

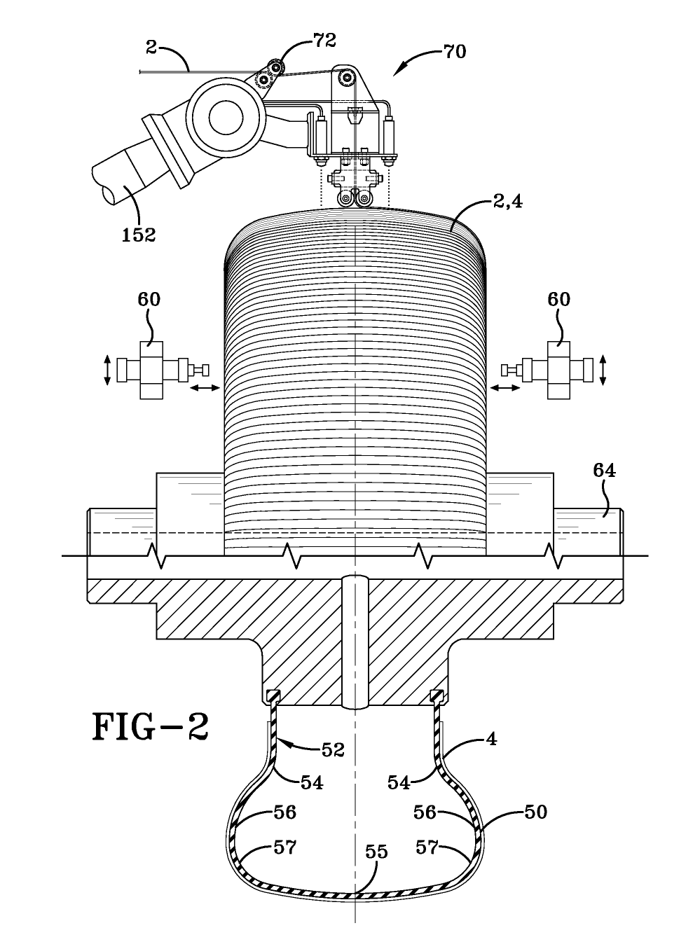

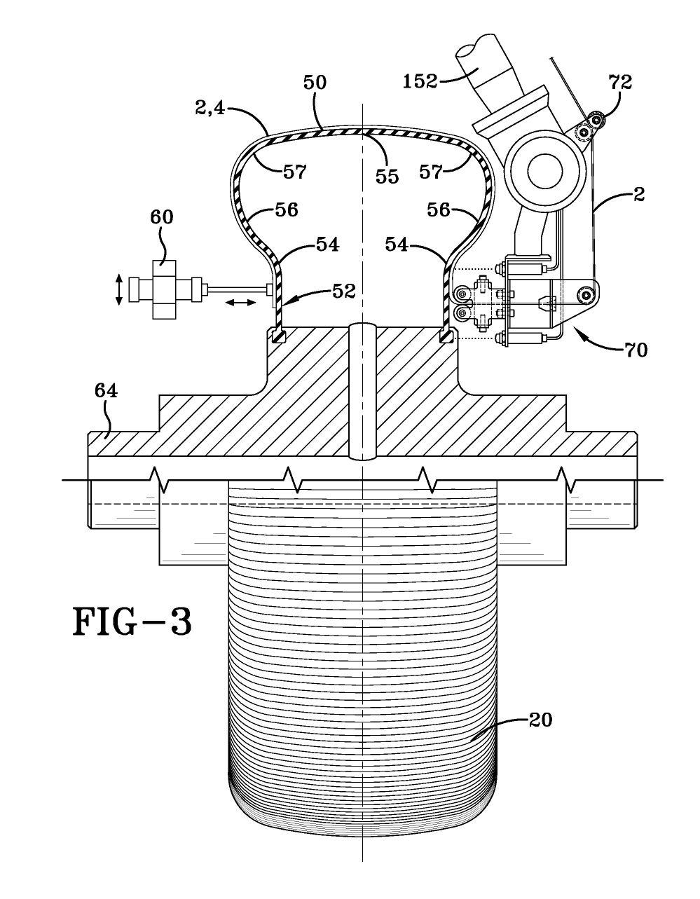

With reference to FIGS. 2 and 3, a cross-sectional view of the toroidal mandrel 52 for use with the present invention is shown. Radially inner portions 54 on each side 56 of the toroidal mandrel 52 have a concave curvature that extends radially outward toward a crown area 55 of the toroidal mandrel 52. As the concave cross section extends radially outward toward an upper sidewall portion 57, the curvature transitions to a convex curvature in what is otherwise known as the crown area 55 of the toroidal mandrel 52. This cross section very closely duplicates the final, as molded, cross section of a tire.

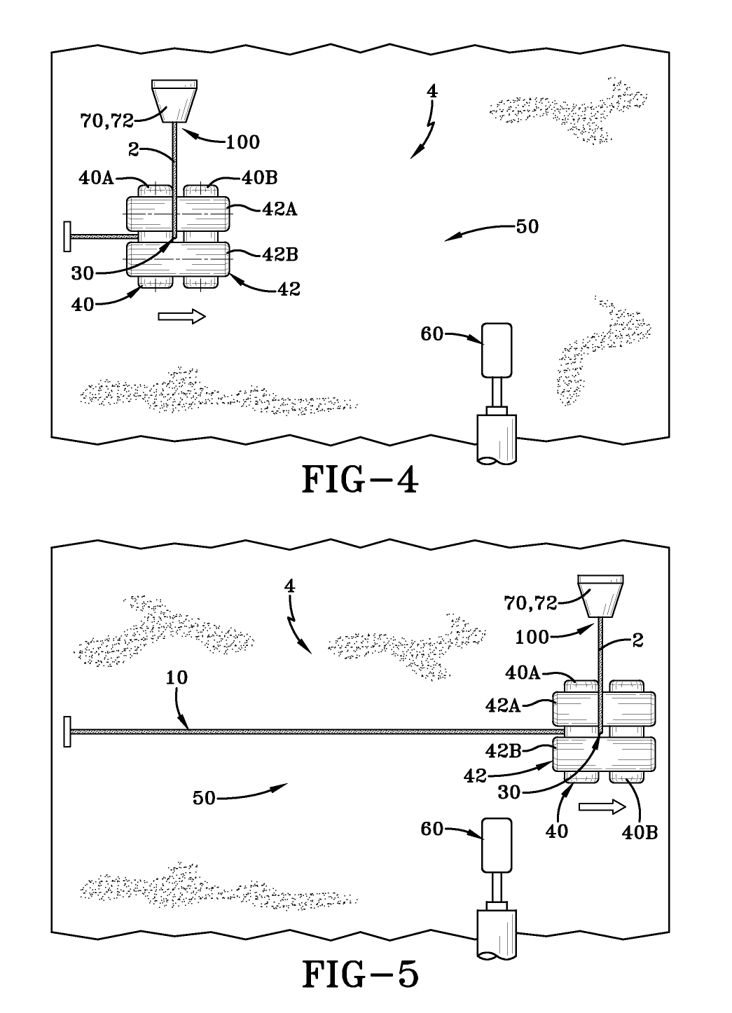

With reference to FIGS. 4 through 9, the means for guiding the dispensed cords has a ply mechanism 70 as shown in a schematic form which illustrates how the ply cord 2 is laid onto the elastomeric surface 4 in the predetermined ply path 10. The schematic views illustrate the basic working components of the ply mechanism 70 and how the ply mechanism 70 operates to place the ply cords 2 in a precise location.

To advance the ply cords 2 on the predetermined ply path 10, the ply mechanism 70, which contains two pairs of parallel pins or rollers 40, 42 with the second pair 42 placed 90° relative to the first pair 40 and in a physical space of about one inch above the first pair 40 and forms a center opening 30 between the two pairs of rollers, which enables the predetermined ply path 10 to be centered. As illustrated, the ply cords 2 are held in place by a combination of embedding the cord into the elastomeric surface 4 previously placed onto the toroidal surface 50 and the surface tackiness of the uncured surface. Once the ply cords 2 are properly applied around the entire circumference of the toroidal surface 50, a subsequent lamination of elastomeric topcoat compound (not shown) can be used to complete the construction of the carcass 20.

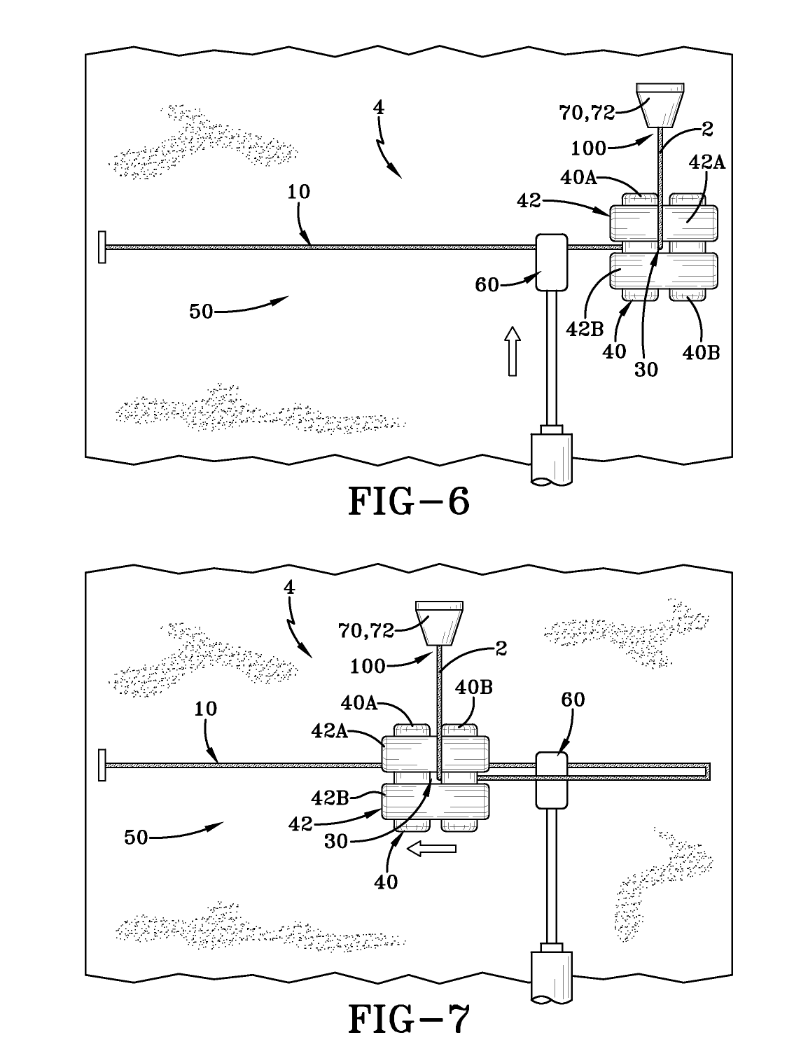

As illustrated in FIG. 4, a bottom pair of rollers 40 uses a first roller 40A to embed the ply cord 2 on a forward traverse across the toroidal surface 50. In FIG. 5, once the predetermined cord path 10 has been transferred across the toroidal surface 50, the apparatus 100 stops and a holding and loop forming plate mechanism 60 advances onto the ply cord 2 and presses the ply cord against the toroidal surface 50, as illustrated in FIG. 6. The apparatus 100 then reverses the predetermined ply path 10 forming a loop 12 in the predetermined ply path 10. At this point, a second roller 40B of the first pair 40 pulls the ply cord 2 back across the toroidal surface 50. The top second pair 42 positions the ply cord 2 in a parallel predetermined ply path 10 and creates spacing between the ply cords 2, hereinafter referred to as the pitch, when the toroidal mandrel 52 and the toroidal surface 50 covered by the bottom coat elastomeric layer 4 advances for a return path. In other words, and as shown in FIG. 7, the toroidal surface 50 is indexed, or advanced slightly, allowing a circumferential spacing or pitch P to occur between the first ply path down in the second return ply path. As illustrated in FIG. 7, the loop 12 that is formed on the reverse traverse is slightly shifted and therefore allowed to be pulled against the loop forming mechanism 60 as the ply cord 2 clinches against the pin to create the desired loop position.

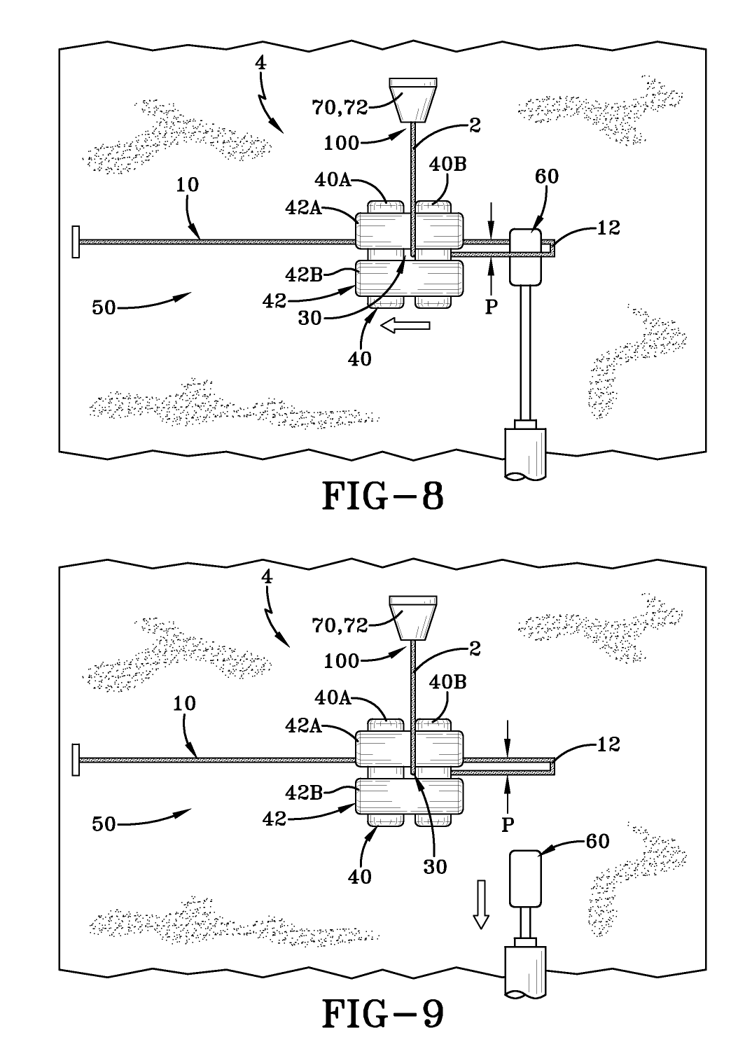

As shown in FIG. 8, a looped end 12 is formed and the second ply path 10 is laid on the toroidal surface 50 parallel to the first ply path 10. As shown in FIG. 9, the loop mechanism 60 then retracts and the second ply path 10 is completed. This process is repeated to form a series of ply cords 2 that are continuous and parallel within at least certain portions of the ply path 10. This is accomplished by having the toroidal mandrel 52 with the toroidal surface 50 with an elastomeric layer 4 laminated onto the toroidal surface to index or advance uniformly about its axis with each traverse of the pair of rollers pins 40, 42 to create a linearly parallel ply path 10 uniformly distributed about the toroidal surface 50. By varying the advance of the ply cord 2 as the apparatus 100 traverses, non-linear parallel cord paths 10 may be formed to tune tire stiffness and to vary flexure with the load.

Preferably, the ply cord 2 is wrapped around a tension or ply mechanism 70 to adjust and maintain the required tension in the ply cord. If the tension is too high, the ply cord 2 will lift from the elastomeric layer 4 when the roller pins 40, 42 reverse direction. If the tension is too low, the ply cord 2 will not form a loop at a correct length around the loop pin mechanism 60. As an example, tension on the ply cord 2 is created as the ply cord passes between a series of rollers 72 capable of adjusting and maintaining tension, as needed for the process and the roller 40, 42. The amount of tension applied should be sufficiently small so that the ply cords 2 do not lift from the placed position on the toroidal surface 50. In other words, the ply cord 2 rests on the toroidal surface 50 positioned and stitched to an elastomeric layer 4 such that the tack between the ply cord and the elastomeric layer is larger than the tension applied by the ply mechanism 70. This permits the ply cords 2 to lay freely on the toroidal surface 50 without moving or separating during the ply construction step. This is significantly different from other conventional mechanisms, which require linear paths and a large amount of tension to maintain the paths 10 as the equipment is traversing over a convex surface to create a laminated ply.

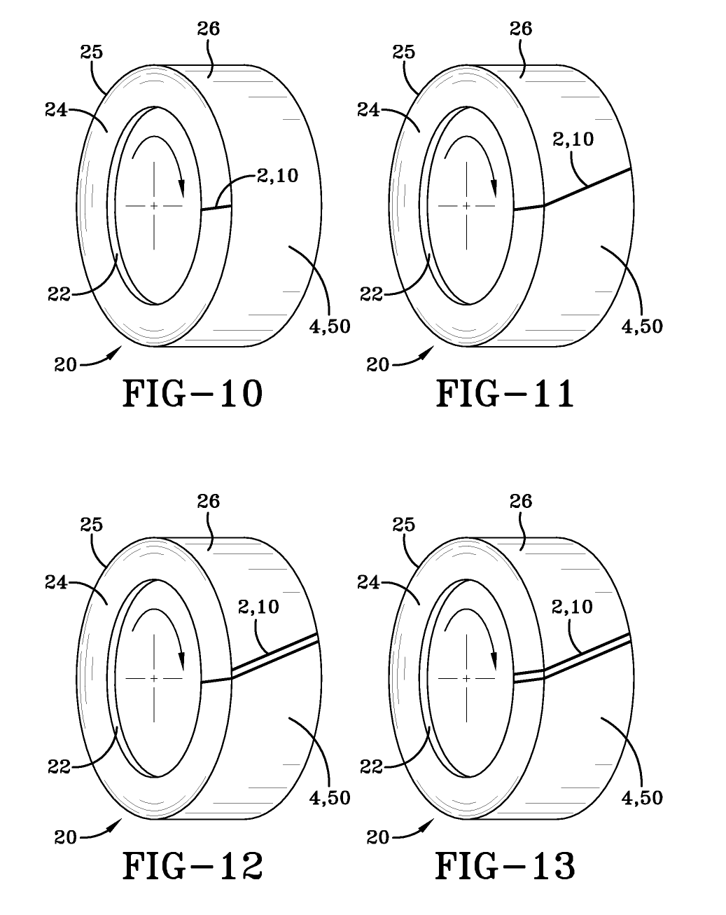

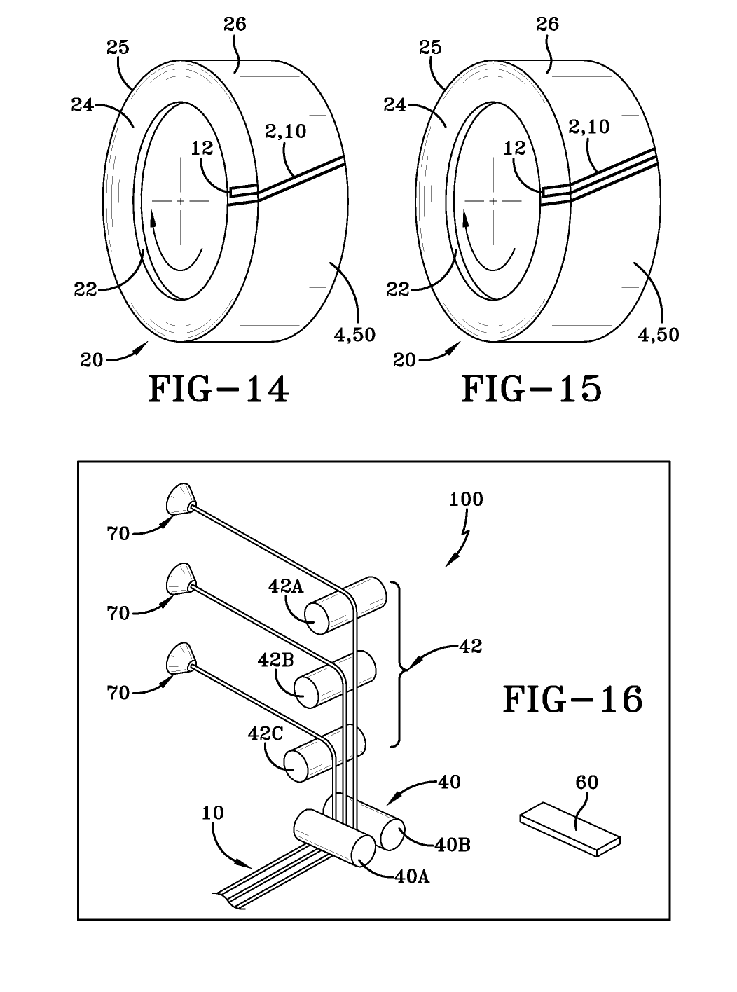

With reference to FIGS. 10-15, the three dimensional view of a cylinder represents how the predetermined ply path 10 is initiated along what would generally be considered the bead region 22 of a carcass 20 along a tire sidewall 24 toward a shoulder region 25 of the toroidal surface 50 and then traverses across the toroidal surface 50 in an area commonly referred to as the crown 26. In FIG. 11, the ply path 10 is laid at a slight angle. While the ply path 10 may be at any angle, including radially at 90° or less, the ply path also can be applied in a non-linear fashion. As shown in FIG. 12, once the ply cord 2 is traversed completely across the toroidal surface 50 and down the opposite side, the loop 12 is formed as previously discussed and the ply cord is brought back across the crown 26. In FIG. 13, the ply cord 2 then proceeds down the tire sidewall 24 toward the bead region 22 where the ply cord is turned and forms a loop 12, as previously discussed, and then traverses back across the toroidal surface 50 in a linear path 10 parallel to the first and second ply cord paths 10. This process is repeated in FIGS. 14 and 15 as the toroidal surface 50 is indexed, creating a very uniform and evenly spaced ply cord path 10.

With reference to FIG. 16, the ply mechanism 70 can be provided with additional rollers 40 such that multiple ply paths 10 can be traversed about the toroidal surface 50. Three dispensing spools 74 traverse three rollers 42A, 42B, 42C, which are spaced in a staggered sequence, permitting openings between each pair of rollers to continue to guide the ply cords 2 while the lower or bottom pair of rollers 40A, 40B provide the stitching of the ply cords to the toroidal surface 50. Again, the same loop mechanism 60 can be used for clinching the ply cords 2 at each loop end 12 (only one loop mechanism 60 shown). However, there typically are a pair of loop mechanisms, one being on each side of the toroidal surface 50.

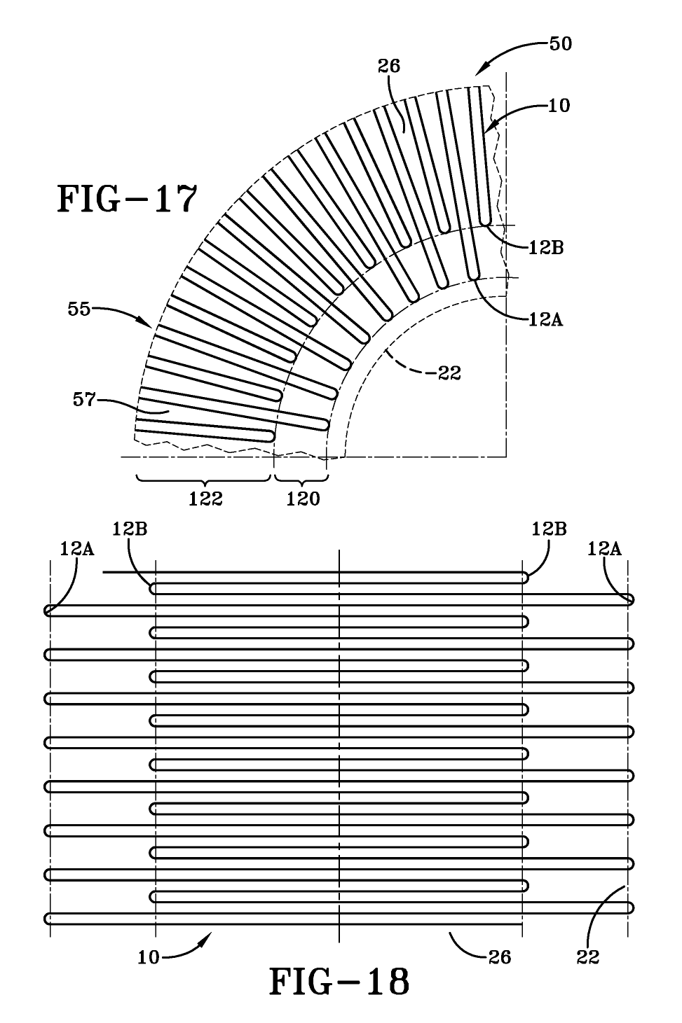

With reference to FIG. 17, a ply path 10 is shown whereby the loop ends 12B can be adjusted radially outward. The loop 12, while being part of a continuous strand of ply cord 2, is only partially shown going up to the sidewall 26 and terminating there. This continuous strand of ply cord 2 may create a ply path 10 whereby the loop ends 12B of the first set of adjacent pairs of ply paths 10 have loop ends 12B at a diameter slightly higher than the second pair of loop ends 12A. This may be repeated in an alternating fashion. This particular cord path 10 creates a cord path as illustrated in FIG. 18, shown in a flat orientation. Thus, fewer cord ends 12A may be spaced at the bead attachment area 22 while, in the crown area 26, additional ply cord paths 10 may be added. Depending on the ply cord diameter, the ends per inch are physically limited by the diameter of the ply cord 2. For example, passenger tires typically cannot exceed 30 ends per inch with minimum rivet or rubber spaced between the ply cords 2. In order to achieve a higher ends per inch, fine ply cords 2 must be used and there is a limit to the strength of such fine ply cords. However, as a tire carcass with a flat formed ply expands into the toroidal configuration, the ply cord spacing, or pitch (P), is stretched in such a fashion that the cords per inch near the crown area 26 of the tire are oftentimes at least half the number in the bead area. This physical limitation can be corrected by the judicious use of the ply endings 12 in different diameters, as illustrated in FIGS. 18-21. In FIG. 18, a cord spacing of 30 ends per inch could achieve a crown cord spacing of 30 ends per inch. The reason is the doubling of the ply cords 2 in the crown area 26 achieved by shifting the looped end 12B slightly above the bead area 22. Thus, in the toroidally shaped ply path 10, it is possible to maintain a uniform ply path all the way across the carcass structure. This enables a tire designer to use finer cords or fewer cords and yet still achieve the same strength of other conventional tires.

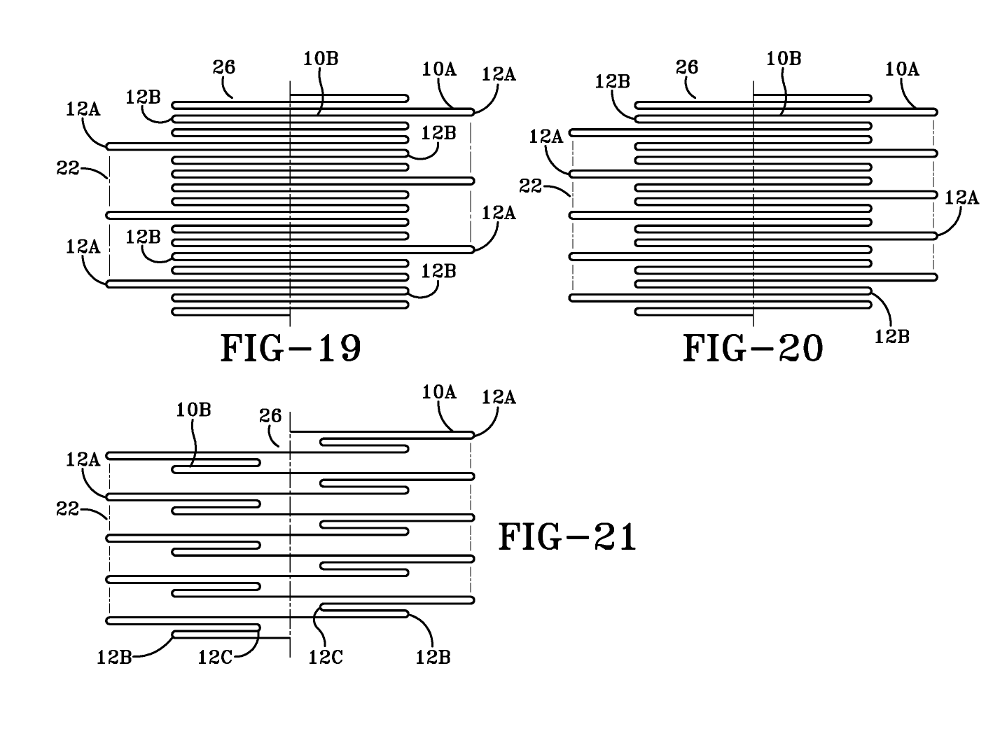

With reference to FIG. 19, one long ply cord path 10A can be used across the tire, then the two short ply cord paths 10B can be applied, and then one long cord ply path 10A on the opposite side. The long ply cord paths 10A are circumferentially offset on a pattern of two short paths 10B being between each circumferentially offset long ply cord paths 10A. Thus, four such ply cord path short ends 12B are on each side between the long ends 12A.

FIG. 20 shows a ply path construction whereby only one such short ply cord path 10B is between circumferentially offset long paths 10A. In FIG. 21, each ply cord path 10 creates a circumferentially offset long ply path 10A. Thus, on each half of the ply cord path as shown in FIG. 21, there is a long 10A, then a short 10B, then a long ply cord path 10A formed by loop ends 12A, 12B, and 12C.

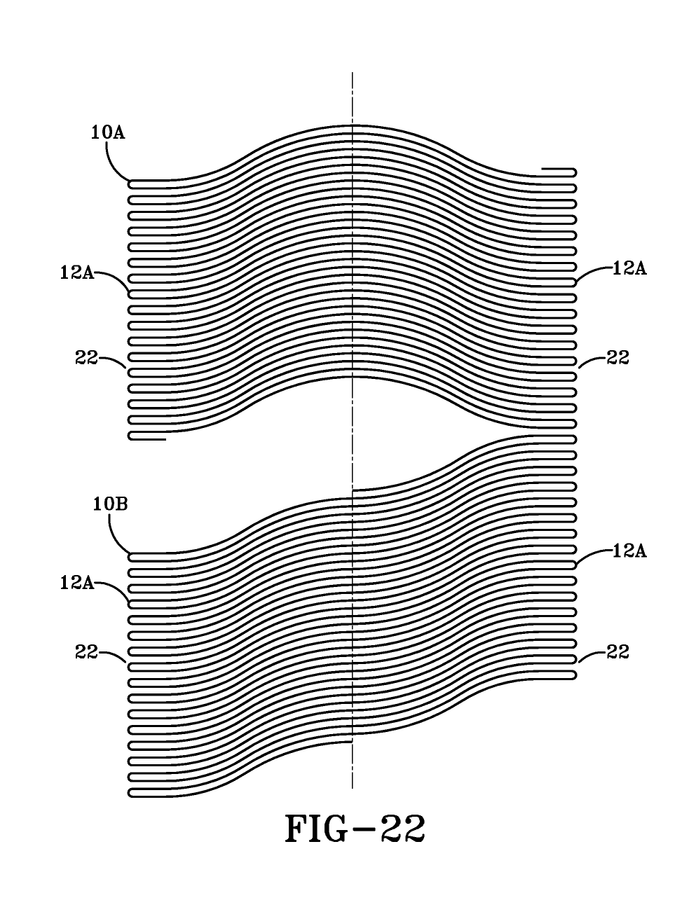

With reference to FIG. 22, two ply cord paths 10A, 10B are shown that extend end to end in a repeating fashion. The ply cord paths 10A, 10B show the possibility of creating two layers. A first layer of parallel ply cord paths 10A is shown with a curvature in one direction. The second ply cord path 10B of FIG. 22 could be a second layer of ply cord paths that could be applied continuously over the top of the first ply cord path 10A. Both of these ply cord paths 10A, 10B demonstrate the ability to make nonlinear cord paths in a uniform fashion. This technique may greatly facilitate the construction of a true geodesic ply cord path tires as a viable and manufacturingly feasible tire. Almost all nonlinear or geodesic type ply cord paths 10 are simply approximations due to the fact that the ply cords 2 are not laid in a fashion that is truly representative of the tire's internal shape or inflated shape as cured. As Purdy, in his book, Mathematics Underlying the Design of Pneumatic Tires, noted at page 84, “It is virtually impossible, by any acceptable means, to produce tire beads by the winding process that are uniform in size, shape, or in tension in the cords in the bead region. It is largely for such reasons that the cord winding machines have been of limited value in forming geodesic cord paths.” The apparatus 100 allows the ply cord paths to be placed in almost exactly the same positions as they will be in the inflated and cured tire, thus making such non-linear plied tires feasible.

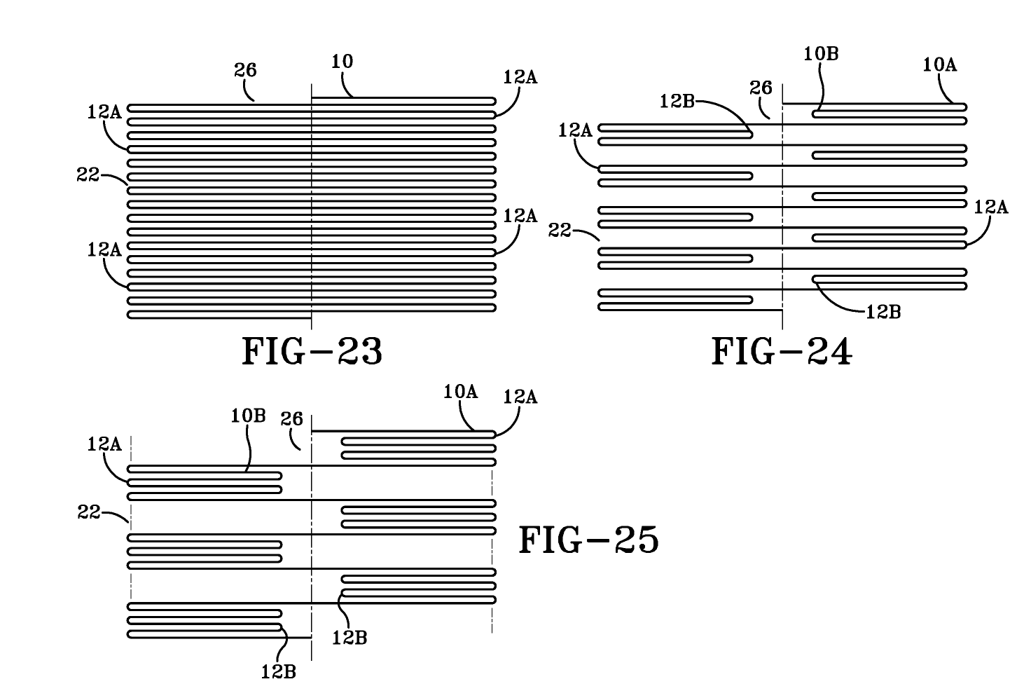

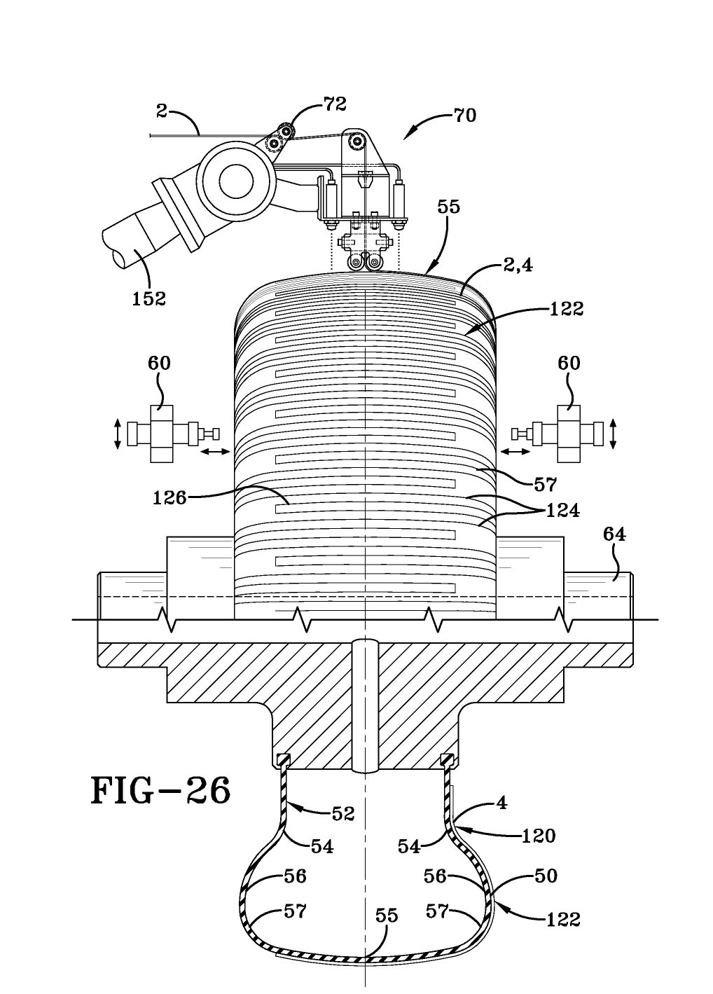

With reference to FIG. 23, the carcass ply 20 shows how a standard tire, conventionally manufactured, could be built where the ply endings 12 are at the same location. With reference to FIGS. 24 and 25, predetermined ply paths 10 are designed such that the sidewall will have an increased number of cords extending up toward the crown area 26 but will stop short of crossing the crown area at loop end 12B and will return by traversing back and then create a continuous ply across the entire toroidal surface 50. These ply paths 10 provide only a portion of the ply cords 2 actually crossing the centerline of the tire under the crown area 26. In most light weight passenger and truck tires, the ply cords 2 crossing the centerline are of little structural value based in part to the tire's belt reinforcing structure, which arguably transmits all the loads across the tire crown area 26. Accordingly, the use of a large number of ply cords 2 across the crown area 26 is a redundancy that adds no great structural value. The ply cord paths 10 of FIGS. 24 and 25 provide a split ply concept, but with the advantage that at least every second or every third ply cord path 10 crosses the crown 26 creating enhanced structural value. In other words, instead of simply relying on split ply paths 10B, these have an alternating continuous ply path 10A across the crown area 26 that provides additional safety and reliability to the tire.

As demonstrated by FIGS. 17 and 26, the toroidal surface 50 follows the curvature of a tire in substantially finished configuration and dimension. As explained, the mandrel 52 has multiple concave curvatures forming the toroidal surface 50. A concave curvature 120 on each side of the mandrel begins radially outward from the bead attachment area 22. A second outward sidewall curvature 122 extends radially outward from each first concave curvature outward toward the crown area 55 of the mandrel 52. As the mandrel cross section extends radially outward toward the upper sidewall portion 57, the curvature of the sidewalls 122 transitions to a convex curvature in what is otherwise known as the crown area 55 of the mandrel 52. The cross section closely duplicates the finished, as molded, cross section of a tire. As shown in FIGS. 15-17 and as previously explained, one or more cords in continuous lengths are embedded in the elastomeric layer 4 on the toroidal surface 50. Longer cord paths 124 may be initiated radially opposite a first concave curvature 120 on one side of the mandrel 52 and extend therefrom through the sidewall curvature and over the crown area 55. The longer cord path 124 may further extend to the first concave curvature 120 on the opposite mandrel side adjacent the bead attachment area 22.

Alternatively, or in conjunction with the longer cord paths 124, one or more shorter cord paths 126 may be formed. The shorter cord paths 126 may initiate opposite a first concave curvature 120 on one side of the mandrel 52 adjacent the bead attachment area 22. The shorter cord path 126 may therefrom extend through the sidewall curvature 122 and over the crown area 55, or terminate within the sidewall curvature 122. The shorter cord path 126, extended over the crown area 55, may have a looped end located at the upper sidewall of the opposite mandrel side. Such a shorter cord path 126, by ending at a higher location on the opposite sidewall of the mandrel 52, may reduce the concentration of cord paths in the bead area of the tire. The shorter cord paths 126 further conserve cord material in the finished tire and reduce manufacturing cost. Accordingly, cord paths forming a ply layer may be custom designed such that cord paths have differing path extensions and lengths. The shorter paths may terminate before crossing the equatorial plane of the mandrel (tire) or cross over the crown area to the sidewall on the opposite side. The longer paths may extend from bead attachment region 22 to bead attachment region 22 on the opposite side, crossing the crown region 26 of the tire. As a result, a cord layer may be constructed having fewer cord paths present (lower cord path density) at the bead attachment area 22 and a higher ply cord path density at the crown region 26 of the tire.

FIG. 17 represents one such cord ply configuration having cord paths of differing lengths. One ply path 10 exists whereby loop ends 12B of a shorter cord path are placed and located radially outward of the sidewall curvature 122 of the toroidal surface 50. Loop ends 12A of longer cord paths are placed and located radially inward of the toroidal surface 50 opposite the first concave curvature 120 at the bead attachment area 22. The loop ends 12B of the first set of adjacent pairs of cord paths 10 and the loop ends 12A of the adjacent set of cord paths are thus located at different respective radial locations relative to the first and second curvatures 120, 122 of the toroidal surface 50. The ends 12A extend through the first and second concave curvatures 120, 122 of the toroidal surface 50 to the bead attachment area 22, while the ends 12B terminate radially outward of the first concave curvature 120 opposite the sidewall of the toroidal surface. Consequently, fewer cord ends 12A are spaced radially below the first concave curvature 120 at the bead attachment area 22 than in the crown area 26 where a higher cord path density exists.

A tire may accordingly be constructed having cord ply cord paths of differing lengths. A like number of longer and shorter cord paths, or a different number of longer and shorter paths, may be employed depending on the tire performance characteristics desired. The longer cord paths may be constructed to extend over the crown region 26 of the toroidal surface 50 to the bead attachment areas 22. The shorter cord paths may be constructed to have loop ends that terminate either in the crown region 26, or the sidewall region 24. The cord paths may be advantageously constructed through placement and embedding one or more cords in continuous lengths onto the elastomeric layer 4 in predetermined relatively longer and shorter cord paths, the longer cord paths extending from a respective side of the toroidal surface 50 over the convex crown region 26 of the toroidal surface and one or more relatively shorter cord paths having opposite path ends located within a sidewall or crown region (FIG. 18) or the convex crown region of the toroidal surface. Thus, by having one or more cord paths extend between opposite path ends located radially outward of the first or second concave curvatures 120, 122, while other cord paths extend radially to the bead attachment area 22, the desired result of a higher cord density (cord ends per inch) at the crown area and a lower cord density at the bead attachment area 22 may be achieved.

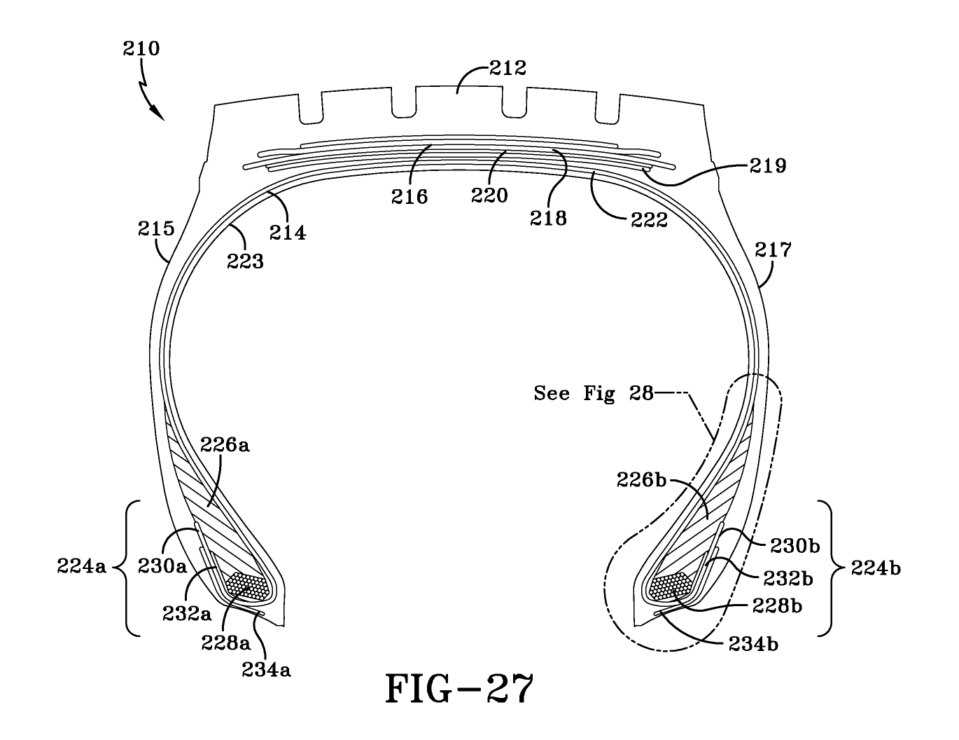

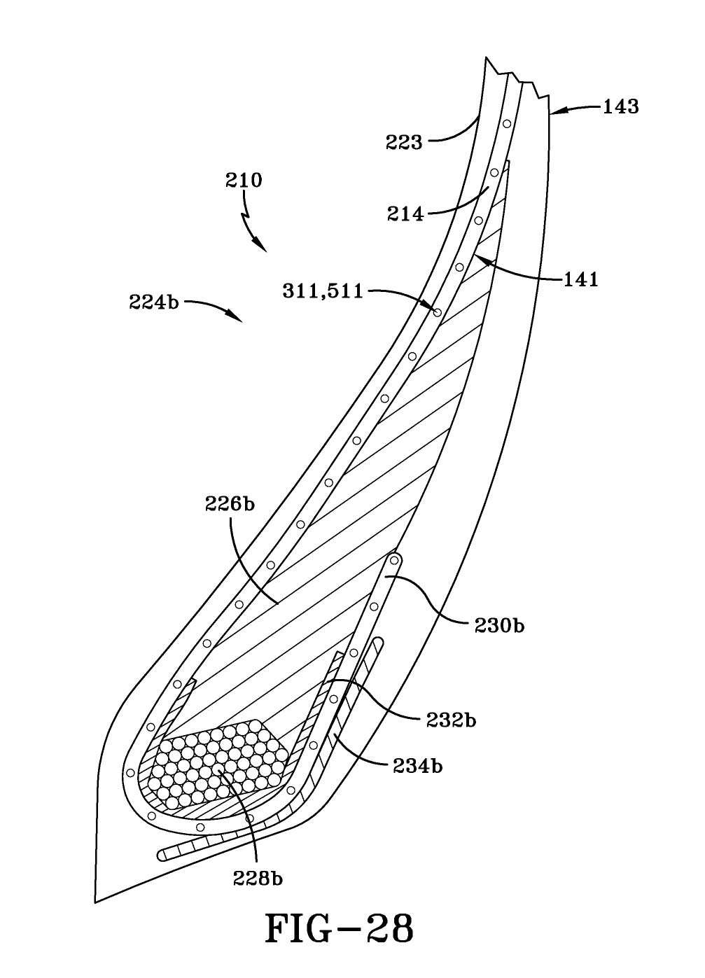

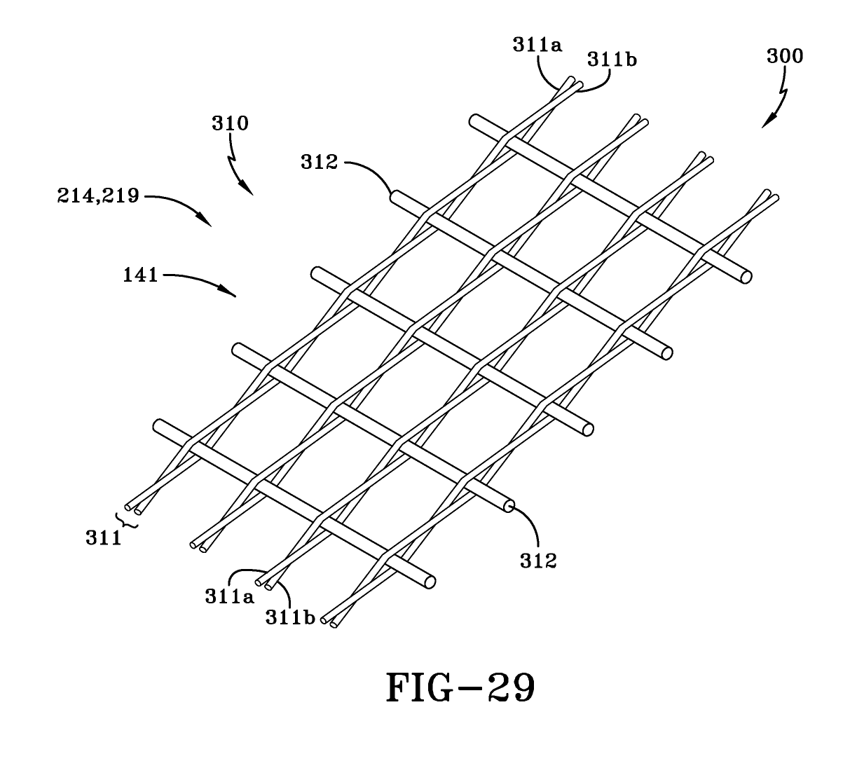

FIG. 27 shows an example tire 210 for use with the present invention. The example tire 210 may be built utilizing the above described method and apparatus 100. The example tire 210 has a tread 212, an innerliner 223, a belt structure 216 comprising belts 218, 220, a carcass 222 with a single carcass ply 214, an underlay 219 between the tread and the belt structure, two sidewalls 215, 217, and two bead regions 224a, 224b comprising bead filler apexes 226a, 226b and beads 228a, 228b. The example tire 210 is suitable, for example, for mounting on a rim of a passenger vehicle. The carcass ply 214 includes a pair of axially opposite end portions 230a, 230b, each of which is secured to a respective one of the beads 228a, 228b. Each axial end portion 230a or 230b of the carcass ply 214 is turned up and around the respective bead 228a, 228b to a position sufficient to anchor each axial end portion 230a, 230b, as seen in detail in FIG. 28.

The carcass ply 214 and/or underlay 219 may be a conventional rubberized ply having a plurality of substantially parallel carcass reinforcing members made of such material as polyester, rayon, or similar suitable organic polymeric compounds. The carcass ply 214 may engage the axial outer surfaces of two flippers 232a, 232b and two chippers 234a, 234b.

If the example tire 210 is built utilizing the above described method and apparatus 100, the carcass ply 214 and underlay 219 will likely comprise Single End Dipped (SED) cords. For production efficiency, the SED cords will be large diameter cords. In accordance with the present invention, the use of square woven fabric made of filament yarns of different stress-strain characteristics for warp and weft will improve production cost and time. The fabric may be constructed with the Leno (standard or 2 T) weaving technique. The following materials may be utilized for warp and/or weft: PEN, PET, PK, PBO, PVA, Rayon, Nylon 6 and 6,6, aramid, carbon fiber, and glass fiber. The warp yarn may be of different modulus than the weft yarn. Further, warp yarns within the same fabric may also vary, such as aramid warp yarn combined with nylon weft yarn. Utilization of such a fabric for the entire carcass ply 214 and the entire underlay 219 may shorten the winding process compared to the use of the above described Single End Dipped cords for the carcass ply and underlay. The fabric may be dipped, tackified, and woven to the specified width (i.e., prefabricated). Advantageously, the fabric need not be calendered (no more need of extruder or gear pumps) and may be applied directly at a tire building machine, as described above.

In accordance with the present invention, the example carcass ply 214 and/or underlay 219 may be reinforced with a woven or knitted reinforcing structure 141. The woven reinforcing structure 141 may comprise parallel carcass reinforcing members (weft) 312, 512 of the carcass ply 214 and additional supporting members (warp) 311, 511 for supporting the cords during the tire building process. The woven or knitted fabric of the reinforced ply 214 and/or underlay 219 may be constructed by placing a series of strips adjacent to each other at the ply mechanism 70.

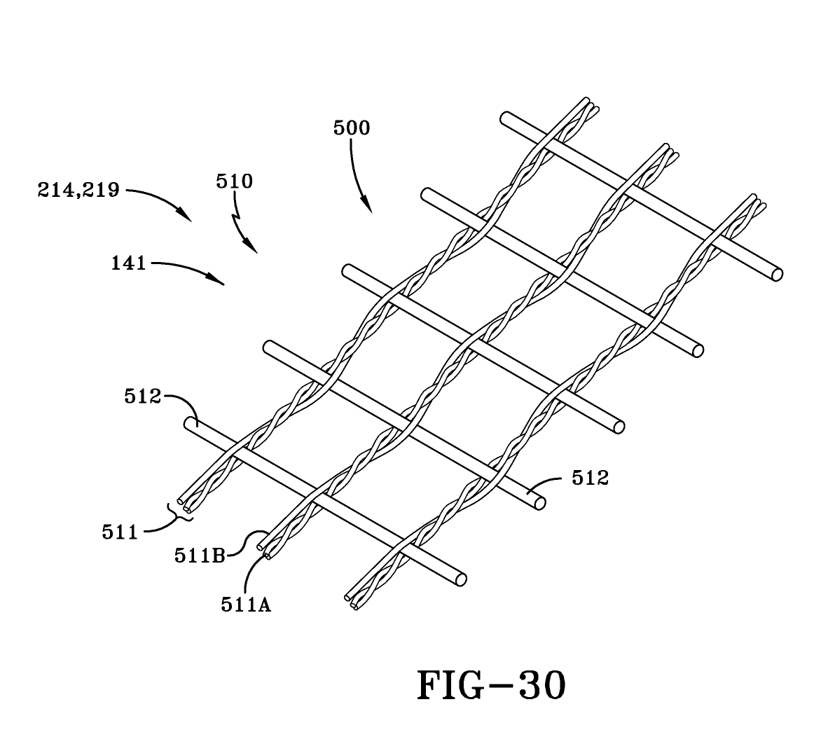

One example woven reinforcing structure 141 for the carcass ply 214 and/or underlay 219 may define a layer of LENO weave fabric. As illustrated in the example of FIGS. 28 and 29, a woven reinforcing structure 141 may comprise a layer or layers 300 of LENO fabric 310 with warp yarn pairs 311 extending generally in a circumferential direction of the pneumatic tire 10 and weft yarns 312 extending generally in a radial direction of the pneumatic tire. Each warp yarn pair 311 may have warp yarns 311a and 311b twisting around each other between fill weft yarns 312.

As illustrated alternatively in the example of FIGS. 28 and 30, another example woven reinforcing structure 141 for the carcass ply 214 and/or underlay 219 may define a woven reinforcing structure 141 having a layer or layers 500 of LENO 2T fabric 510 with warp yarns 511 extending generally in a circumferential direction of the pneumatic tire 10 and weft yarns 512 extending generally in the radial direction of the pneumatic tire. Each warp yarn 511 may have a first set of twisted pairs of filler warp yarns 511 a extending on one side of, and perpendicular to, fill weft yarns 512 and a second set of warp yarns 511b extending generally parallel to and below the filler warp yarns 511a and alternating above/below the weft yarns 512.

As seen in FIGS. 28 and 29, the warp yarn pairs 311 extend circumferentially along the LENO fabric 310. It is the warp yarns 311a and 311b that provide the maintenance of proper spacing and relative orientation during the tire building process, as described above. The warp yarns 311, 511 may be a spun staple yarn, a multifilament yarn, and/or a monofilament yarn formed of a suitable material.

As stated above, examples of suitable materials for the warp yarns 311, 511 include polyamide, aramids (including meta and para forms), polyester, polyvinyl acetate, nylon (including nylon 6, nylon 6,6, and nylon 4,6), polyethylene naphthalate (PEN), rayon, polyketone, carbon fiber, PBO, and glass fiber.

The weft yarns 312, 512 may be a multifilament yarn, and/or a monofilament yarn formed of a suitable material. Examples of suitable materials for the weft yarns 312, 512 include polyamide, aramids (including meta and para forms), polyester, polyvinyl acetate, nylon (including nylon 6, nylon 6,6, and nylon 4,6), polyethylene naphthalate (PEN), cotton, rayon, polyketone, carbon fiber, PBO, and glass fiber.

The warp and/or weft yarns 311, 312, 511, 512 may also be hybrid yarns. Hybrid yarns may be multiple yarns, made up of at least 2 fibers of different material (for example, aramid and nylon). These different fiber materials may produce hybrid yarns with various chemical and physical properties. Hybrid yarns may be able to change the physical properties of the final product in which they are used. Example hybrid yarns may be an aramid fiber with a nylon fiber, an aramid fiber with a rayon fiber, and an aramid fiber with a polyester fiber.

As used herein, mechanical resiliency of a yarn is the ability of the yarn to displace longitudinally without an elastic deformation of the material. Mechanical resiliency allows the LENO fabric 310, 510 to have a minor amount of resilient elongation for compatibility with the example tire 10, but use stronger yarns in the carcass ply 214 or underlay 219.

The woven reinforcing structure 141 is an open construction fabric which permits the strike through of rubber in a tire 10 for a better bonded construction. The openness of the fabric used for the woven reinforcing structure 141 may be determined by the spacing and character of the warp yarns 311 or 511. The weft yarns 312 are typically spaced as necessary to maintain the position of the warp yarns 311 or 511 provide suitable strength to the carcass ply 214 and/or underlay 219.

The woven reinforcing structure 141 may be treated with an adhesion promoter. Examples of adhesion promoters include resorcinol formaldehyde latex (RFL), isocyanate based material, epoxy based material, and materials based on melamine formaldehyde resin. The woven reinforcing structure 141 may also have a tackified finish, or green tack, applied for facilitating adhesion during the building process of a green tire. The selection of materials for the tackified finish may depend upon the materials selected for use in the tire 10. Tackified finishes may be achieved by various methods such as coating the fabric in an aqueous blend of rosin and rubber lattices, or with a solvent solution of an un-vulcanized rubber compound.

Further, the woven or knitted reinforcing structure 141 may comprises multiple layers, e.g. two, three, or even more layers, of the LENO fabric 310, 510 to provide extra strength for the carcass and/or underlay. When more than one layer of LENO tape 310, 510 is used for the carcass ply 214 and/or underlay 219, a layer of unvulcanized rubber may be placed between the layers of LENO tape to ensure an effective bond.

The formation of the woven reinforcing structure 141 may begin with the acquisition of the basic yarns for the fabric. Subsequently, the yarns may be twisted to provide additional mechanical resilience. After the twisting, warp yarns 311, 511 may be placed on a large beam for the formation of the woven reinforcing structure 141. The woven reinforcing structure 141 may be formed by LENO weaving with the appropriate spacing of the warp yarn pairs 311, 511. After the woven reinforcing structure 141 formation, the structure may be finished with adhesive promoter, such as an RFL treatment. If a tackified finish is desired, this is provided following the adhesive promoter finishing. The final layer may be slit into the specific widths.

The woven reinforcing structure 141 in accordance with the present invention may reduce cost and complexity of the tire building process without lessening rolling resistance, high speed capability, and handling characteristics. Additionally, the woven reinforcing structure 141 may reduce noise due to vibration damping (i.e., circumferential reinforcement provided by the warp yarns 311 or 511).

One example construction for the woven reinforcing structure 141 may comprise 1220/1 Dtex 14 EPI (ends per inch) rayon warp yarns and 2200/2 Dtex 26 EPI polyester weft yarns. In general, the warp pairs 311, 511 may have a density of 10 EPI to 18 EPI and the weft yarns 312, 512 may have a density of 5 EPI to 35 EPI.

The woven reinforcing structure 141 of square woven fabric made may be made of filament yarns of different stress-strain characteristics for warp and weft. The fabric 300, 500 may be produced with the Leno (standard or 2T) weaving technique or knitted. The warp yarns 311, 511 may be different modulus than the weft yarns 312, 512, or the same.

The fabric 310, 510 may be used as carcass reinforcement and/or underlay reinforcement. The fabric 310, 510 may be dipped, tackified, and woven/knitted to a specified ply width. The fabric 300, 500 does not require calendering and may thus be applied directly at a tire building machine, as described above.

Further, there is now no requirement to calender the fabric 310, 510 or slit the material prior to application on a green tire. Rolls of fabric strips produced at specified width may be supplied to a tire plant and directly applied on a tire building machine.

The warp yarn may provide a circumferential reinforcement whereas a conventional carcass provides only a radial reinforcement. The woven or knitted reinforcing structure 141 provides additional circumferential stiffness to a carcass package, thus reducing rolling resistance.

As stated above, a carcass ply 214 or underlay 219 with a reinforcement structure 141 in accordance with the present invention produces an excellent and less costly and more efficiently manufactured pneumatic tire 10. This carcass ply 214 and/or underlay may thus enhance tire production, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). Important structural elements are the carcass ply and underlay, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of carcass ply cords or underlay cords on noise characteristics, handling, durability, comfort, etc. in pneumatic tires. Mechanics of Pneumatic Tires, pages 80 through 85.

These complexities are demonstrated by the below table of the interrelationships between tire performance and tire components.

| | | CARCASS PLY | | | | | |
|---|---|---|---|---|---|---|---|
| | LINER | & UND'LY | APEX | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, carcass ply and underlay cord characteristics affect the other components of a pneumatic tire (i.e., carcass ply/underlay affects apex, belt, overlay, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the carcass ply or underlay cords of a pneumatic tire is modified with the intent to improve one functional property of the pneumatic tire, any number of other functional properties may be unacceptably degraded. Furthermore, the interaction between the carcass ply/underlay cords and the apex, belt, carcass, and tread may also unacceptably affect the functional properties of the pneumatic tire. A modification of the carcass ply or underlay cords may not even improve that one functional property because of these complex interrelationships.

Thus, as stated above, the complexity of the interrelationships of the multiple components makes the actual result of modification of a carcass ply or underlay, in accordance with the present invention, impossible to predict or foresee from the infinite possible results. Only through extensive experimentation have the carcass ply 214, underlay 219, and woven reinforcement structure 141 of the present invention been revealed as an excellent, unexpected, and unpredictable option for a tire carcass.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

While the present invention has been illustrated by a description of various illustrative embodiments and while these embodiments have been described in some detail, it is not the intention of the applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims, wherein what is claimed is:

What is claimed is:

1. A pneumatic tire having an axis of rotation, the pneumatic tire comprising:
a reinforced ply placed in a predetermined location on a toroidal surface;
a tread disposed radially outward of the reinforced ply; and
a belt structure disposed radially between the reinforced ply and the tread, the reinforced ply comprising at least one layer of an open construction woven or knitted fabric having warp yarns extending in a circumferential direction and weft yarns extending in a radial direction.

2. The pneumatic tire of claim 1 wherein the woven fabric has a 5 EPI to 18 EPI warp pair construction and a 5 EPI to 35 EPI weft construction.

3. The pneumatic tire of claim 2 wherein the warp yarns are 1220/1 Dtex rayon and the weft yarns are 2200/2 Dtex polyester.

4. The pneumatic tire of claim 3 wherein the warp yarns have a density of 14 EPI and the weft yarns have a density of 26 EPI.

5. The pneumatic tire of claim 1 wherein the fabric has a LENO 2T configuration with a 5 EPI to 18 EPI warp pair construction and a 5 EPI to 35 EPI weft construction.

6. The pneumatic tire of claim 1 wherein the fabric has a knitted configuration.

7. The pneumatic tire of claim 1 wherein the pneumatic tire is a high performance tire.

8. The pneumatic tire of claim 12 wherein the woven fabric further comprises an adhesion promoter disposed thereon.

9. The pneumatic tire of claim 1 wherein the reinforced ply has two or more layers of woven or knitted fabric.

10. The pneumatic tire of claim 1 wherein the warp yarns comprise at least two fibers of different fiber materials.

11. The pneumatic tire of claim 1 wherein the reinforced ply is a carcass ply comprised entirely of the woven or knitted fabric.

12. The pneumatic tire of claim 1 wherein the reinforced ply is an underlay ply comprised entirely of the woven or knitted fabric.

13. The pneumatic tire of claim 1 wherein the woven or knitted fabric of the reinforced ply is dispensed from one or more spools.

14. The pneumatic tire of claim 1 wherein the woven or knitted fabric of the reinforced ply is constructed by placing a series of strips adjacent to each other.
